(19) United States
(12) Patent Application Publication
(10) Pub. No.: US 2025/0347546 A1
(43) Pub. Date: Nov. 13, 2025

(54) MODULAR CORIOLIS FLOWMETER

(71) Applicant: Endress+Hauser Flowtec AG, Reinach (CH)

(72) Inventors: Marc Werner, Grenzach-Wyhlen (DE); Benjamin Schwenter, Ettingen (CH)

(21) Appl. No.: 18/871,087

(22) PCT Filed: May 31, 2023
(86) PCT No.: PCT/EP2023/064476

§ 371 Date: Dec. 2, 2024

(30) Foreign Application Priority Data
Jun. 1, 2022 (DE) 10 2022 113 872.0

(51) Int. Cl. G01F 15/18; G01F 1/84; G06F 30/17; G06F 30/23; G06F 113/14

(52) U.S. Cl. CPC G01F 15/185; G01F 1/8472; G06F 30/17; G06F 30/23; G06F 2113/14

(57) ABSTRACT

A modular Coriolis flowmeter for determining a process variable of a flowable medium includes: a measuring tube module having at least one measuring tube a connector element for detachably connecting the measuring tube module to a process line, and a connecting element for connecting the at least one measuring tube to the connector element; and a support module with a receptacle for detachably securing the measuring tube module in the support module, wherein the connecting element has a connecting element contact section which has a deflection of less than 1% relative to a maximum deflection of the at least one measuring tube, and wherein the connector element and the connecting element are configured such that a mechanical contact between the connector element and the connecting element occurs, in particular exclusively, within the connecting element contact section.

The invention relates to a modular Coriolis flowmeter for determining a process variable of a flowable medium.

Process measurement technology field devices with a sensor of the vibration type and especially Coriolis flowmeters have been known for many years. The basic structure of such a measuring device is described in, for example, EP 1 807 681 A1, wherein reference is made in full to this publication with respect to the structure of a generic field device in the context of the present invention.

Typically, Coriolis flowmeters have at least one or more oscillating measuring tubes which can be set into oscillation by means of a vibration exciter. These vibrations are transmitted along the tube length and are varied by the type of flowable medium located in the measuring tube and by its flow rate. At another point in the measuring tube, a vibration sensor or, in particular, two vibration sensors spaced apart from one another can record the varied vibrations in the form of a measurement signal or a plurality of measurement signals. An evaluation unit can then determine the mass throughflow, the viscosity, and/or the density of the medium from the measurement signal(s).

The measuring tubes are usually connected to the housing via a distributor piece. The three aforementioned components are welded together. However, Coriolis flowmeters with replaceable disposable measuring tube arrangements are known. For example, in WO 2011/099989 A1, a method is thus taught for producing a monolithically formed measuring tube arrangement of a Coriolis flowmeter with bent measuring tubes, wherein the measuring tube body of the respective measuring tubes is at first formed as a solid made up of a polymer, and the channel for conducting the flowable medium is subsequently machined into said solid. WO 2011/099989 A1 teaches, similarly to US 10,209,113 B2, a connecting element that is configured to receive and support a replaceable measuring tube module comprising thin-walled plastic tubes. The measuring tube module is fastened in a support device, equipped with the necessary exciters and sensors, by means of the connecting element.

The mechanical properties of the measuring tube modules can vary considerably; therefore, specific parameters such as calibration factor and zero point of the modular measuring tube module must be established before use. It has been found that the zero point determined during the calibration procedure can differ from the zero point actually present during use.

The object of the invention is to reduce any influences on the zero point.

The object is achieved by the modular Coriolis flowmeter according to claim 1 and by the method for designing the measuring tube module according to claim 16.

The modular Coriolis flowmeter according to the invention for determining a process variable of a flowable medium comprises:
a measuring tube module comprising:
   at least one measuring tube for conducting the medium;
   a primary exciter component;
   a primary sensor component;
   a connector element for detachably connecting the measuring tube module to a process line;
   a connecting element for connecting the at least one measuring tube to the connector element,
      wherein the connecting element is connected to the at least one measuring tube, in particular integrally bonded,
      wherein the connecting element and the connector element are formed of at least two parts;
a support module comprising:
   a receptacle for detachably securing the measuring tube module in the support module,
   a secondary exciter component that complements the primary exciter component,
   a secondary sensor component that complements the primary sensor component, characterized in that
   the connecting element has a connecting element contact portion which, when the at least one measuring tube is excited with a mechanical vibration, has a deflection of less than 1% %, in particular less than 0.1% %, and preferably less than 0.01% %, relative to a maximum deflection of the at least one measuring tube, and
   the connector element and the connecting element are designed such that mechanical contact between the connector element and the connecting element occurs, in particular exclusively, within the connecting element contact portion.

One advantage of the modular Coriolis flowmeter is the replaceability of the measuring tube module and at the same time the reusability of the support module, which usually houses the measuring and evaluation electronics (with a corresponding processor) for operating the Coriolis flowmeter and for evaluating the measurement signals and, alternatively, also a display for outputting the measurement results. This makes the modular Coriolis flowmeter ideal for single-use applications in bioprocessing plants and/or pharmaceutical processing plants.

The individual modules of the modular Coriolis flowmeter can be connected to one another via form-fitting and/or force-fitting connections, which can be easily re-released by the operator of the modular Coriolis flowmeter, particularly without the need for tools. For this purpose, on the support module, a fastening device can be provided, which is designed to detachably fasten the measuring tube module in the receptacle.

The connecting element is the interface between the measuring tube or measuring tubes and the connector element. The way in which the connecting element interacts with or makes contact with the connector element influences the zero point of the modular Coriolis flowmeter. In order to achieve the object, it is ensured that the contact between the connecting element and the connector element be clearly defined, and that only those portions of the connecting element which undergo a deflection below a tolerable limit value when the measuring tube(s) vibrate be in contact with the connector element. The limit value defines a deflection of less than 1%, in particular less than 0.1%, and preferably less than 0.01%, relative to a maximum deflection of the at least one measuring tube.

The connector element is responsible for connecting the at least one measuring tube to the process line. If more than one measuring tube is used, the connector element can therefore be a distributor piece. Alternatively, the connector element functions as a connector adapter.

Advantageous embodiments of the invention are the subject matter of the dependent claims.

One embodiment provides that the mechanical vibration have a vibration frequency of less than 1,000 Hz and greater than 100 Hz, in particular less than 750 Hz and greater than 150 Hz, and preferably less than 500 Hz and greater than 200 Hz.

One embodiment provides that the connector element have at least a first contact surface which is in contact with the connecting element contact portion.

Permanent contact is thus made by means of the first contact surface. This surface is not necessarily continuous and can therefore also be composed of a plurality of partial surfaces.

One embodiment provides that the first contact surface occupy at most 10%, in particular at most 5% and preferably at most 3%, of an entire projected area which results from an orthogonal projection of all cross-sectional planes through the connector element onto a projection plane.

The connector element does not necessarily have to be solid. Particularly in the case of injection-molded parts, it is advantageous if the injection-molded part is hollow, at least in portions, and has a substantially constant wall thickness. The cross-sectional area of the connector element is therefore defined by the area enclosed by an outer border of the connector element. This corresponds to the projected area resulting from the orthogonal projection of all cross-sectional planes passing through the connector element.

One embodiment provides that the connector element have a raised portion which comprises the first contact surface.

According to the embodiment, for a defined point of contact with predetermined contact surfaces between the connector element and the connecting element, a raised portion is provided on the side, facing the connecting element, of the end body. This raised portion can comprise the entire first contact surface. The provision of the raised portion results in a predefined gap being formed between the connecting element and the connector element, which gap prevents critical regions of the connecting element from coming into contact with the connector element.

One embodiment provides that the connector element have a plurality of raised portions, each of which comprises a partial surface of the first contact surface.

As an alternative to the previous embodiment, a plurality of raised portions can also be provided on a side, facing the connecting element, of the connector element, which forms the permanent contact between the connector element and the connecting element. In this case, the first contact surface is divided into the plurality of raised portions.

One embodiment provides that the at least one measuring tube be curved,
wherein the at least one measuring tube has a straight inlet region and a straight outlet region,
wherein the connecting element has two connecting element openings,
wherein the at least one measuring tube extends through one of the two connecting element openings in each of the inlet area and the outlet area,
wherein the at least one measuring tube has a longitudinal axis in each of the inlet area and the outlet area,
wherein two planes running in parallel with one another delimit a region on the connecting element in which the connecting element contact portion, in particular the first contact surface, is located,
wherein the longitudinal axes each lie in one of the two planes.

One embodiment provides that the connector element have a second contact surface which is only in contact with the connecting element contact portion when a medium, in particular having a flow rate of at least 1 m/s and/or a medium pressure of greater than 1 bar, in particular greater than 2 bar, flows through a connector element channel of the connector element.

According to the embodiment, additional contact points are provided; however, these are not permanently in contact with the connecting element, but, rather, only when medium flows through the connector element. Otherwise, the second contact surface is also spaced apart from the side, inclined towards the connector element, of the connecting element.

One embodiment provides that the at least one measuring tube be curved,
wherein the at least one measuring tube has a straight inlet region and a straight outlet region,
wherein the connecting element has two connecting element openings,
wherein the at least one measuring tube extends through one of the two connecting element openings in each of the inlet area and the outlet area,
wherein the at least one measuring tube has a longitudinal axis in each of the inlet region and the outlet region,
wherein two planes running in parallel with one another delimit a region on the connecting element in which the second contact surface is located,
wherein the longitudinal axes each lie in one of the two planes.

One embodiment provides that the measuring tube module have at least one sealing means, at least portions of which are arranged between the connector element and the connecting element,
wherein the sealing means is designed such that the connecting element and the connector element, in particular a lower connecting element surface inclined towards the connector element and a connector element surface inclined towards the connecting element, are spaced apart, at least in portions.

The sealing means is clamped between the connecting element and the connector element and prevents the medium from escaping at the interface between the measuring tube and the connector element. The sealing means is of such a size that the connector element is spaced apart from the connecting element except for predefined contact surfaces. This thus creates a defined gap between the connecting element and the connector element.

One embodiment provides that the connector element be connected to the connecting element by means of at least one fastening means, in particular in a force-fitting and/or form-fitting manner.

Suitable fastening means include the fastening means taught in PCT/EP2021/083119 or DE 102020131563.5, for example. Reference is made in full to the two patent documents mentioned.

One embodiment provides that the first contact surface be designed such that it surrounds a fastening means surface,
wherein the fastening means passes through the fastening means surface.

According to the embodiment, the first contact surface or a corresponding partial surface of the first contact surface can be annular.

One embodiment provides that the measuring tube module have at least one contact means which is arranged between the connecting element and the connector element and facilitates the mechanical contact.

Instead of a raised portion or portions on the connector element and/or the connecting element, separate spacer parts or contact means can be arranged between the connecting element and the connector element. These can be integrally bonded to the connector element and/or the connecting element or can be arranged between the two elements in a form-fitting and/or force-fitting manner.

One embodiment provides that the measuring tube module comprise a first, in particular curved, measuring tube,
wherein the measuring tube module comprises a second, in particular curved, measuring tube,
wherein the connecting element has two connecting element openings through which the first measuring tube extends,
wherein the connecting element has two further connecting element openings through which the second measuring tube extends.

One embodiment provides that the connecting element have a further connecting element contact portion which, when the at least one measuring tube is excited with the mechanical vibration, has a deflection of more than 1%, in particular more than 0.1%, and preferably more than 0.01%, relative to the maximum deflection,
wherein the connector element and the connecting element are designed such that there is no mechanical contact between the connector element and the connecting element within the connecting element contact portion.

The method according to the invention for designing a measuring tube module for use in a modular Coriolis flowmeter, in particular in the modular Coriolis flowmeter according to the invention, wherein the measuring tube module comprises at least one measuring tube, a connector element for detachably connecting the measuring tube module to a process line, and a connecting element for connecting the at least one measuring tube to the connector element, comprises the method steps of:
establishing the deflection of the connecting element when the at least one measuring tube is mechanically vibrated;
establishing a connecting element contact portion,
   wherein the deflection of the connecting element in the connecting element contact portion is less than 1%, in particular less than 0.1%, and preferably less than 0.01%, relative to a maximum deflection of the at least one measuring tube; and
connecting the connector element to the connecting element and the at least one measuring tube such that mechanical contact between the connector element and the connecting element occurs, in particular exclusively, within the connecting element contact portion.

For a more stable zero point—that is the value that exists when there is no medium or a stationary medium—it is particularly important to determine the vibration behavior of the connecting element beforehand. If the vibration behavior is known, the surfaces of the connecting element which, when excited, have a vibration amplitude of less than 1%, in particular less than 0.1%, and preferably less than 0.01%, relative to a maximum deflection of the at least one measuring tube, can be determined. If these are known, this must be taken into account when designing the connector element and/or the connecting element. When connecting the connector element to the measuring tube(s), it must be ensured that mechanical contact occur only within the established surfaces.

In addition, a method step can be provided in which the connector element is formed in such a way that, when the connector element is arranged on the measuring tube and the connecting element, mechanical contact occurs only between the previously established and determined surfaces.

One embodiment provides that the mechanical vibration have a vibration frequency of less than 1,000 Hz and greater than 100 Hz, in particular less than 750 Hz and greater than 150 Hz, and preferably less than 500 Hz and greater than 200 Hz.

One embodiment provides that, in order to establish the deflection of the connecting element, the measuring tube module be arranged in a receptacle of a support module of the Coriolis flowmeter.

One embodiment provides that a defined prestressing force be applied to the measuring tube module, in particular to the connecting element, in order to establish the deflection of the connecting element.

One embodiment provides that the deflection of the connecting element be determined for a measuring tube module that does not comprise a connector element.

One embodiment provides that the deflection of the connecting element be established by means of a simulation method.

One embodiment provides that the simulation method comprise finite element calculations.

The invention is explained in greater detail with reference to the following figures. In the drawings:

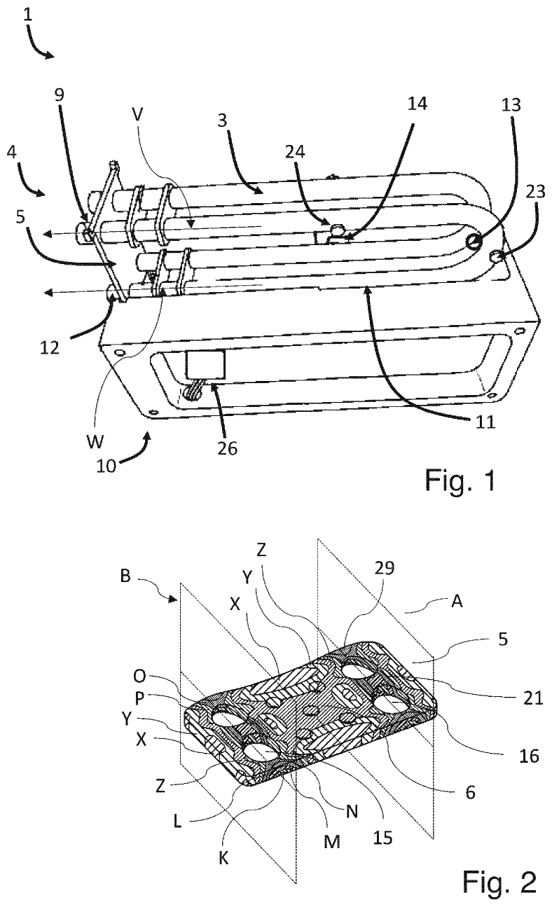

FIG. 1 is a perspectival view of a modular Coriolis flowmeter;

FIG. 2 is a technical simulation of the vibration behavior of the connecting element when the two measuring tubes are excited such that they vibrate;

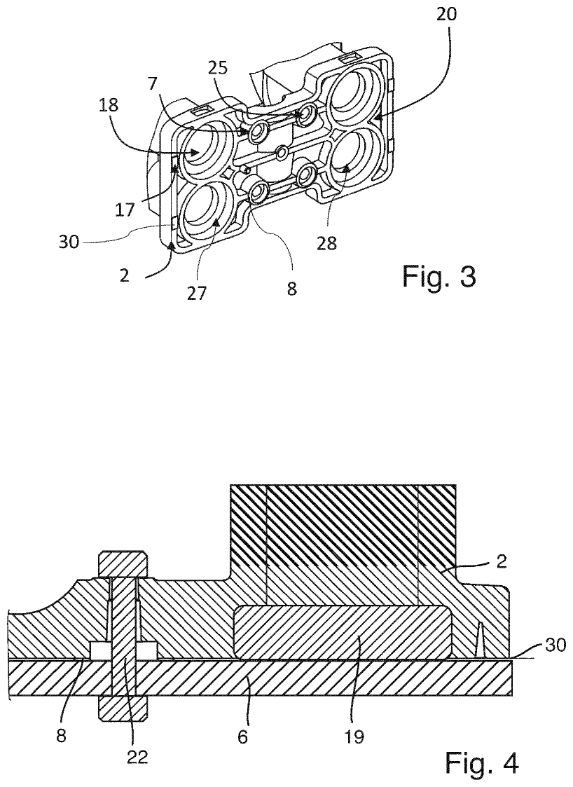

FIG. 3 is a perspectival view of the bottom of a connector element;

FIG. 4 is a detail view of a cross-section through a connector element and a connecting element; and

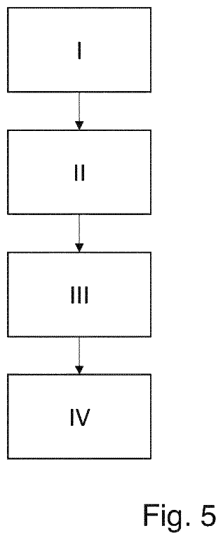

FIG. 5 shows a method chain for an embodiment according to the invention of the method for designing a measuring tube module for use in a modular Coriolis flowmeter.

FIG. 1 is a perspectival view of a modular Coriolis flowmeter for determining a process variable of a flowable medium. The process variables are usually the mass flow, the density, and/or the viscosity of the medium. The modular Coriolis flowmeter 1 comprises a measuring tube module 4 and a support module 10. The measuring tube module 4 is designed as a replaceable disposable part, while the support module 10 is used as a reusable part. For this purpose, the measuring tube module 4 can be mechanically detachably connected to the support module 10. The measuring tube module 4 comprises at least one measuring tube 3 for conducting the medium, which has an inlet region 9 and an outlet region 12. The at least one measuring tube 3 can be made of a metal, a plastic, and/or a glass. In the illustrated embodiment, the measuring tube module 4 comprises exactly two curved metal measuring tubes, each with a straight inlet region 9 and a straight outlet region 12. The curved sub-portion is located between the inlet region 9 and the outlet region 12 in the flow direction. Alternatively, the measuring tube module 4 can also comprise only precisely one curved measuring tube. The inlet portions of the two measuring tubes are connected to one another via at least one coupler; in the case shown, there are exactly two planar couplers. The same also applies to the outlet portions of the two measuring tubes.

A primary exciter component 23 and at least one primary sensor component 24 are attached to each of the measuring tubes. The primary exciter component 23 can, for example, be a permanent magnet which is attached to a lateral surface of the measuring tube. The primary sensor component 24 may also be a permanent magnet. The measuring tubes shown each have exactly two primary sensor components 24 per measuring tube, which are each arranged in a straight sub-portion of the measuring tube, while the primary exciter component 23 is arranged in a curved sub-portion of the measuring tube in each case.

The measuring tube module 4 further comprises a connecting element 5 for connecting the two measuring tubes to a connector element (not shown). The connector element is designed to connect, in particular detachably, the measuring tube module 4, in particular the inlet region 9 and the outlet region 12 of each measuring tube, to a process line (not shown). The connecting element 5 is integrally bonded to the at least one measuring tube 3 and is to be understood as a separate component from the connector element. Therefore, the connecting element 5 and the connector element are formed of at least two parts. Alternatively, the connecting element can be connected to the at least one measuring tube 3 in a force-fitting and/or form-fitting manner. In the embodiment shown, the plate-shaped connecting element 5 is metallic, planar, and connected to the two measuring tubes. The connecting element 5 has four connecting element openings 15, 16, through each of which the straight inlet and outlet portions of the two measuring tubes extend. The integral bonds at the corresponding connecting element openings 15, 16 between the connecting element and the measuring tubes are formed by a welded connection. Alternative connection options are also known. The connection can also be formed by an adhesive bond, fusion bond, screw connection, or (ultrasonic) rivet connection.

The support module 10 comprises a receptacle 11 for detachably securing the measuring tube module 4 in the support module 10. The receptacle 11 is delimited by at least four walls. In the illustrated embodiment, the receiving volume of the receptacle 11 is defined by precisely four walls. The receptacle 11 can have a groove into which at least in portions of the connecting element 5 can be inserted. Alternatively, the support module 10 can have a receiving surface on which the connecting element rests when the measuring tube module 4 is installed. According to one variant (not shown), the receptacle 11 can be delimited by precisely five walls. The measuring tube module 4 can thus be inserted into the receptacle 11, where it is fixed using a fastening device (not shown). In the illustrated embodiment, the mounting direction of the measuring tube module 4 is perpendicular to the longitudinal axis of the measuring tube module 4 and also to the longitudinal axis of the receptacle 11.

Alternatively, the receptacle 11 and the support module 10 can be designed such that the mounting direction of the measuring tube module 4 is oriented in parallel with the longitudinal axis of the measuring tube module 4 and also to the longitudinal axis of the receptacle 11.

The support module 10 is preferably made of a corrosion-resistant metal or a plastic. At least one secondary exciter component 13 that complements the primary exciter component 23 and at least one secondary sensor component 14 that complements the primary sensor component 24 are arranged in the support module 10. If two primary sensor components are provided per measuring tube, two secondary sensor components are also provided per measuring tube. Alternatively, when the secondary exciter component 13 and the secondary sensor component 14 are arranged between the two measuring tubes, exactly one secondary exciter component 13 can also be provided for two primary exciter components 23, and exactly one secondary sensor component 13 can also be accordingly provided for two primary sensor components 23. Irrespective thereof, the secondary sensor component 14 is arranged on the support module 10 in such a way that, when the measuring tube module 4 is arranged in the receptacle 11, the primary sensor component 24 interacts, in particular magnetically, with the secondary sensor component 14. The secondary exciter component 13 is arranged on the support module 10 such that, when the measuring tube module 4 is arranged in the receptacle 11, the primary exciter component 23 interacts, in particular magnetically, with the secondary exciter component 13. A coil is suitable as the secondary sensor component 14 and the secondary excitation component 13. The secondary sensor component 14 and the secondary exciter component 13 are electrically connected to the control unit 26 and are controlled thereby or provide said unit with measured values. The control unit 26 is suitable and configured for processing and evaluating established measured values. For this purpose, the control unit 26 has at least one processor and electronic components.

FIG. 2 shows a technical simulation of the vibration behavior of a connecting element 5 that is substantially cuboid-apart from the rounded corners—when the two measuring tubes are excited to vibrate. The measuring tubes were taken into account for the simulation, but are not shown for the sake of explaining the invention. However, the connecting element openings 15, 16 are shown for this purpose. The connecting element 5 is graphically divided into a plurality of sub-portions K, L, M, N, O, P, X, Y, and Z, which each differ by differing deflections of the connecting element 5. Sub-portions with identical patterns are or can be assigned to the same letter (K, L, M, N, O, P, X, Y, Z). According to the invention, the connecting element 5 has a connecting element contact portion 6 which, when the at least one measuring tube 3 is excited with a mechanical vibration, has a deflection of less than 1%, in particular less than 0.1%, and preferably less than 0.01%, relative to a maximum deflection of the at least one measuring tube. The connecting element contact portion 6 is thus located-according to the embodiment shown-within the sub-portions having the letters X, Y, and Z. The mechanical vibration has a vibration frequency of less than 1,000 Hz and greater than 100 Hz, in particular less than 750 Hz and greater than 150 Hz, and preferably less than 500 Hz and greater than 200 Hz. The connector element (see FIG. 3) and the connecting element 5 are two separate components and are designed according to the invention such that mechanical contact between the connector element and the connecting element 5 occurs, in particular exclusively, within the connecting element contact portion 6. For the embodiment shown, this means that contact between the connecting element 5 and the connector element is made exclusively in the sub-portions X, Y, and/or Z. The at least one measuring tube has, or the two measuring tubes each have, a longitudinal axis V, W in the inlet region and in the outlet region. Two parallel planes A, B delimit a region on the connecting element 5 in which the connecting element contact portion 6, in particular the first contact surface, is located. The longitudinal axes V, W each lie in one of the two planes A, B. Further contact points can be provided independently of the first contact surface. Thus, the two parallel planes A, B can also delimit a region on the connecting element 5 in which a second contact surface is located. This means that the second contact surface lies outside the region delimited by the two planes A, B. The connector element is therefore only in contact with the connecting element contact portion 6 when a medium, in particular having a flow rate of at least 1 m/s and/or a medium pressure of more than 1 bar, in particular more than 2 bar, flows through a connector element channel 18 of the connector element 2. Furthermore, it is required that the connecting element 5 have a connecting element portion 29 which, when the at least one measuring tube is excited with the mechanical vibration, has a deflection of more than 1%, in particular more than 0.1%, and preferably more than 0.01%, relative to the maximum deflection. The connector element and the connecting element 5 are designed such that there is no mechanical contact between the connector element and the connecting element 5 within the connecting element portion 29. In the illustrated embodiment, these are the sub-portions having the letters K, L, M, N, O, and P.

A connector element 2 is not shown in FIG. 1 and FIG. 2, but in FIG. 3. FIG. 3 is a perspectival view of the bottom of the connector element 2 according to the invention. The connector element 2 can be designed as a distributor piece. The connector element 2 has at least two connector element openings 27, 28 through which the corresponding inlet portions and outlet portions of the at least one measuring tube extend. In the illustrated design having exactly two measuring tubes, the connector element 2 has precisely four connector openings. The connector element 2 has a connector element channel 18 through which the medium flows. The connector element channel 18 is connected or connectable to the at least one measuring tube 3. The connector element 2 may comprise metal, glass, and/or plastic.

The connector element 2 at least has the first contact surface 7, which is in contact with the connecting element contact portion of the connecting element according to the invention (see FIG. 2). The first contact surface 7 occupies at most 10%, in particular at most 5% and preferably at most 3%, of an entire projected area which results from an orthogonal projection of all cross-sectional planes through the connector element 2 onto a projection plane. In the embodiment shown, the connector element 2 has a plurality of raised portions 8, in particular exactly four raised portions 8 comprising the first contact surface 7, which are arranged to form at least a two-fold, and in particular at least a three-fold, symmetry around a longitudinal axis of the measuring tube module. The plurality of raised portions 8 each have a partial surface of the first contact surface 7, which, altogether, provides the entire first contact surface 7. Alternatively, the connector element 2 can also have only one raised portion 8, which surrounds the first contact surface 7. In the embodiment shown, the first contact surface 7 consists of four, annular partial contact surfaces.

The connector element 2 also has the second contact surface 17, which is only in contact with the connecting element contact portion 6 when a medium, in particular a medium having a flow rate of at least 1 m/s and/or a medium pressure of more than 1 bar, in particular more than 2 bar, flows through the connector element channel 18. For this purpose, a raised portion 30 or a plurality of raised portions 30 may in turn be provided that have the second contact surface. In the illustrated embodiment, the second contact surface 17 consists of four, square partial contact surfaces.

FIG. 4 shows a detail view of a cross-section through an assembled connector element 2 and connecting element 6. The connector element 2 is fastened to the connecting element 6 by means of a fastening means 22. The fastening means 22 extends through a fastening means opening of the connector element 2 and a fastening means opening of the connecting element 6. A gap lies at least in portions between a rear surface, facing the connecting element 6, of the connector element 2 and a surface, facing the connector element 2, of the connecting element 6, i.e., the connector element and the connecting element are spaced apart from one another, at least in portions. The only contact points between the connector element 2 and the connecting element 6 are located on the raised portions 8 of the connector element. Alternatively, the connecting element can also have the raised portions. The connector element 2 also has at least one further raised portion 30 which is not in permanent contact with the connecting element 6. However, mechanical contact between the raised portion 30 and connecting element 6 occurs only when a medium having a flow rate of at least 1 m/s and/or a medium pressure of more than 1 bar, in particular more than 2 bar, flows through the connector element channel of the connector element 2. In this case, the connector element deforms, and the raised portion 30 comes into contact with the connecting element 2.

The measuring tube module also has at least one sealing means 19, which is arranged at least in portions between the connector element 2 and the connecting element 5. The sealing means 19 is designed and dimensioned such that the connecting element 5 and the connector element 2, in particular the rear surface of the connector element 2 and the surface of the connecting element 6, are spaced apart from the connecting element 5, at least in portions. The sealing means 19 can-as shown-be a sealing ring which is arranged in a sealing means receptacle of the connector element.

FIG. 5 shows a method chain of the method according to the invention for designing a measuring tube module for use in a modular Coriolis flowmeter (see FIGS. 1 to 4).

In a first method step I, the deflection of the connecting element is determined during a mechanical vibration of the at least one measuring tube. For this purpose, the measuring tube is vibrated at a vibration frequency of less than 1,000 Hz and greater than 100 Hz, in particular less than 750 Hz and greater than 150 Hz, and preferably less than 500 Hz and greater than 200 Hz. The vibration behavior is determined using a simulation method. A simulation method based upon finite element calculations is particularly suitable for this purpose. An example thereof is shown in FIG. 2. The vibration frequency used there is approximately 303 Hz. To simulate the vibration behavior of the connecting element, the measuring tube module was arranged in a receptacle of the support module. The connector element was omitted. The measuring tube module thus consisted exclusively of the two measuring tubes, the four couplers, the connecting element, the two primary exciter components, and the four primary sensor components. In addition, a defined prestressing force was applied to the measuring tube module in order to simulate the forces acting upon the measuring tube module when it is fixed in the support module.

Once the vibration behavior of the connecting element is known, in a second method step II, a connecting element contact portion is determined in which the deflection of the connecting element is less than 1%, in particular less than 0.1%, and preferably less than 0.01%, relative to a maximum deflection of the at least one measuring tube.

In a third method step III, the connector element is designed in such a way as to ensure that, when the connector element is arranged on the measuring tube and the connecting element, mechanical contact occurs only within the established connecting element contact portion.

In a fourth method step IV, the connector element is connected to the connecting element and the at least one measuring tube in such a way that the mechanical contact between the connector element and the connecting element occurs only within the connecting element contact portion.

Alternatively or additionally, in a method step, the deformation of the connector element can be established which results when a medium, in particular having a flow rate of at least 1 m/s and/or a medium pressure of more than 1 bar, in particular more than 2 bar, flows through a connector element channel of the connector element. Proceeding from the established deformation, a further design of the connector element may be necessary in order to ensure that, if the connector element is deformed due to the medium to be conducted, the new mechanical contact between the connecting element and the connector element also occurs only within the connecting element contact portion.

### List of Reference Signs

1 modular Coriolis flowmeter
2 connector element
3 measuring tube
4 measuring tube module
5 connecting element
6 connecting element contact portion
7 first contact surface
8, 30 raised portion
9 inlet region
10 support module
11 receptacle
12 outlet region
13 secondary exciter component
14 secondary sensor component
15,16 connecting element opening
17 second contact surface
18 connector element channel
19 sealing means
20 connecting element surface
21 connector element surface
22 fastening means
23 primary exciter component
24 primary sensor component
25 fastening means surface
26 control unit
27, 28 connector element opening
A, B plane

1-22. (canceled)

23. A modular Coriolis flowmeter for determining a process variable of a flowable medium, the modular Coriolis flowmeter comprising:
a measuring tube module, comprising:
at least one measuring tube adapted to conduct the medium;
a primary exciter component;
a primary sensor component;
a connector element configured to enable detachably connecting the measuring tube module to a process line; and
a connecting element configured to enable connecting the at least one measuring tube to the connector element,
wherein the connecting element and the connector element are formed of at least two parts, and wherein the connecting element is integrally bonded to the at least one measuring tube;
a support module, comprising:
a receptacle configured to enable detachably securing the measuring tube module in the support module;
a secondary exciter component adapted to complement the primary exciter component; and
a secondary sensor component adapted to complement the primary sensor component,
wherein:
the connecting element includes a connecting element contact portion configured such that, when the at least one measuring tube is excited with a mechanical vibration, the connecting element contact portion has a deflection of less than 1% relative to a maximum deflection of the at least one measuring tube, and
the connector element and the connecting element are configured such that mechanical contact between the connector element and the connecting element occurs exclusively within the connecting element contact portion.

24. The modular Coriolis flowmeter according to claim 23, wherein the mechanical vibration has a vibration frequency of less than 1,000 Hz and greater than 100 Hz.

25. The modular Coriolis flowmeter according to claim 23, wherein the connector element includes at least a first contact surface, which is in contact with the connecting element contact portion.

26. The modular Coriolis flowmeter according to claim 25, wherein the first contact surface occupies at most 10% of an entire projected area resulting from an orthogonal projection of all cross-sectional planes through the connector element onto a projection plane.

27. The modular Coriolis flowmeter according to claim 25, wherein the connector element includes a raised potion comprising the first contact surface.

28. The modular Coriolis flowmeter according to claims 25, wherein the connector element includes a plurality of raised portions, each of which comprises a partial surface of the first contact surface.

29. The modular Coriolis flowmeter according to claim 23, wherein:
the at least one measuring tube is curved;
the at least one measuring tube includes a straight inlet region and a straight outlet region;
the connecting element includes two connecting element openings;
the at least one measuring tube extends through one of the two connecting element openings in each of the inlet region and the outlet region;
the at least one measuring tube has a longitudinal axis in each of the inlet region and the outlet region;
two planes extending parallel to one another delimit a region of the connecting element in which the connecting element contact portion is located; and
the longitudinal axes each lie in one of the two planes.

30. The modular Coriolis flowmeter according to claim 25, wherein the connector element includes a second contact surface which is only in contact with the connecting element contact portion when a medium with a flow rate of at least 1 m/s and/or with a medium pressure of more than 1 bar flows through a connector element channel of the connector element.

31. The modular Coriolis flowmeter according to claim 30, wherein:
the at least one measuring tube is curved;
the at least one measuring tube includes a straight inlet region and a straight outlet region, the connecting element includes two connecting element openings;
the at least one measuring tube extends through one of the two connecting element openings in each of the inlet region and the outlet region;
the at least one measuring tube includes a longitudinal axis in each of the inlet region and the outlet region;
two planes extending parallel to one another delimit a region of the connecting element in which the second contact surface is located; and
the longitudinal axes each lie in one of the two planes.

32. The modular Coriolis flowmeter according to claim 23, wherein the measuring tube module includes at least one sealing means, at least portions of which are arranged between the connector element and the connecting element, and
wherein the sealing means is configured such that the connecting element and the connector element are spaced apart, at least in portions, such that a lower connecting element surface inclined towards the connector element and a connector element surface inclined towards the connecting element are spaced apart.

33. The modular Coriolis flowmeter according to claim 23, wherein the connector element is connected to the connecting element in a force-fitting and/or form-fitting manner by at least one fastener.

34. The modular Coriolis flowmeter according to claim 25, wherein the connector element is connected to the connecting element in a force-fitting and/or form-fitting manner by at least one fastener,
wherein the first contact surface is configured to surround a fastening surface, and
wherein the fastener extends through the fastening surface.

35. The modular Coriolis flowmeter according to claim 23, wherein the measuring tube module includes at least one contact means disposed between the connecting element and the connector element and adapted to facilitate the mechanical contact.

36. The modular Coriolis flowmeter according to claim 23, wherein:
the at least one measuring tube of the measuring tube module includes a curved first measuring tube;
the at least one measuring tube includes a curved second measuring tube;
the connecting element includes two openings through which the first measuring tube extends; and
the connecting element includes two further openings through which the second measuring tube extends.

37. The modular Coriolis flowmeter according to claim 23, wherein the connecting element includes a further connecting element portion which, when the at least one measuring tube is excited with the mechanical vibration, has a deflection of more than 0.01% relative to the maximum deflection,
wherein the connector element and the connecting element are configured such that no mechanical contact occurs between the connector element and the connecting element within the further connecting element portion.

38. A method for designing a measuring tube module for use in a modular Coriolis flowmeter according to claim 23, the method comprising:
determining the deflection of the connecting element when the at least one measuring tube is mechanically vibrated;
establishing a connecting element contact portion,
wherein the deflection of the connecting element in the connecting element contact portion is less than 1% relative to a maximum deflection of the at least one measuring tube; and connecting the connector element to the connecting element and the at least one measuring tube such that mechanical contact between the connector element and the connecting element occurs exclusively within the connecting element contact portion.

39. The method according to claim 38, wherein the mechanical vibration has a vibration frequency of less than 1,000 Hz and greater than 100 Hz.

40. The method according to claim 38, wherein, for determining the deflection of the connecting element, the measuring tube module is disposed in a receptacle of the support module of the Coriolis flowmeter.

41. The method according to claim 40, wherein a defined prestressing force is applied to the connecting element so as to determine the deflection of the connecting element.

42. The method according to claim 38, wherein the deflection of the connecting element is determined for a measuring tube module not comprising a connector element.

43. The method according to claim 38, wherein the deflection of the connecting element is determined by a simulation method.

44. The method according to claim 38, wherein the simulation method includes finite element calculations.

45. The modular Coriolis flowmeter according to claim 23, wherein the deflection of the connecting element contact portion is less than 0.01% relative to the maximum deflection of the at least one measuring tube.

46. The modular Coriolis flowmeter according to claim 24, wherein the vibration frequency of the mechanical vibration is less than 500 Hz and greater than 200 Hz.

47. The modular Coriolis flowmeter according to claim 26, wherein the first contact surface occupies at most 3% of the entire projected area.

48. The modular Coriolis flowmeter according to claim 30, wherein the second contact surface of the connector element is only in contact with the connecting element contact portion when the flow rate of the medium is at least 1 m/s and/or with the medium pressure is more than 2 bar.

49. The modular Coriolis flowmeter according to claim 37, wherein the further connecting element portion has a deflection of more than 1% relative to the maximum deflection when the at least one measuring tube is excited with the mechanical vibration.
